(19) United States
(12) Patent Application Publication
(10) Pub. No.: US 2012/0215453 A1
(43) Pub. Date: Aug. 23, 2012

(54) DEVICE AND METHOD FOR MULTI-DIMENSIONAL COHERENCY DRIVEN DENOISING DATA

(75) Inventor: Gordon POOLE, East Grinstead (GB)

(73) Assignee: CGGVERITAS SERVICES SA, Massy Cedex (FR)

(21) Appl. No.: 13/398,060

(22) Filed: Feb. 16, 2012

Related U.S. Application Data
(60) Provisional application No. 61/445,182, filed on Feb. 22, 2011.

(51) Int. Cl. G06F 19/00; G01V 1/34; G01V 1/36

(52) U.S. Cl. 702/16; 702/17

(57) ABSTRACT

Computing device, computer instructions and method for denoising seismic data recorded with seismic receivers. The method includes receiving the seismic data recorded with the seismic receivers, wherein the seismic data is recorded in a time-space domain; applying with a computing device a high resolution transform to the seismic data in the time-space domain to obtain transformed seismic data in a different domain than the time-space domain, such that the method is amplitude preserving; determining regions of noise and regions of true signal in the transformed seismic data; scaling down the regions of noise; and reverse transforming the transformed seismic data to the time-space domain.

### CROSS REFERENCE TO RELATED APPLICATIONS

The present application is related to and claims the benefit of priority of U.S. Provisional Application Ser. No. 61/445,182, having the title “Multi-Dimensional Coherency Driven Denoising of Irregular Data,” and being authored by Gordon Poole, the entire content of which is incorporated herein by reference.

### BACKGROUND

1. Technical Field

Embodiments of the subject matter disclosed herein generally relate to methods and systems and, more particularly, to mechanisms and techniques for removing noise from seismic data.

2. Discussion of the Background

Marine seismic data acquisition and processing generate a profile (image) of the geophysical structure under the seafloor. While this profile does not provide an accurate location for oil and gas reservoirs, it suggests, to those trained in the field, the presence or absence of them. Thus, providing a high-resolution image of the subsurface is an ongoing process.

Generally, a seismic source is used to generate a seismic signal which propagates into the earth, and it is at least partially reflected by various seismic reflectors in the subsurface. The reflected waves are recorded by seismic receivers. The seismic receivers may be located on the ocean bottom, close to the ocean bottom, below a surface of the water, at the surface of the water, on the surface of the earth, or in boreholes in the earth. The recorded seismic datasets, e.g., travel-time, may be processed to yield information relating to the location of the subsurface reflectors and the physical properties of the subsurface formations, e.g., to generate an image of the subsurface.

Many land and ocean bottom datasets suffer from high levels of noise, which make the task of processing and interpretation difficult. This is more pronounced for low fold datasets. Modern single sensor high fold datasets can also exhibit high noise levels due to poor coupling and ground or mud roll. For such datasets, it can be pragmatic to reduce the noise level rather than to interpolate even more densely.

Denoising algorithms are generally split into two categories: those that are designed to remove random noise and those that remove coherent noise. The removal of random noise normally relies on the fact that while the signal is predictable, the incoherent noise is not. This principle is the basis for fx prediction filtering (see, Canales, L. L., “Random noise reduction,” 54^{th} SEG Annual International Meeting, Expanded Abstracts, 3, no. 1, 525-529, 1984), fx projection filtering (Soubaras, R., “Signal-preserving random noise attenuation by the F-X projection,” 64^{th} SEG Annual International Meeting, Expanded Abstracts, 13, no. 1, 1576-1579, 1994), and other coherency driven techniques (for example, Gulunay et al., “Coherency enhancement on 3D seismic data by dip detection and dip selection,” 77^{th} SEG Annual International Meeting, Expanded Abstracts, 2007).

Other denoising algorithms attempt to mitigate the coherent noise by characteristics that distinguish it from the primary energy. For example, Radon demultiple makes the distinction that on normal moveout corrected common mid-point (CMP) gathers, the primary energy is flat while the multiple energy curves downward (Hampson, D., “Inverse velocity stacking for multiple elimination,” Canadian Journal of Exp. Geophysics, 22, 44-55, 1986). Other coherent energy can be distinguished through modeling and subtraction (see Le Meur et al., “Adaptive ground roll filtering,” 70^{th} EAGE Conference & Exhibition, Expanded Abstracts, 2008).

For random noise, the attenuation algorithms require regularly sampled data. Thus, the irregular datasets need to be regularized prior to denoising. The simplest method of achieving regularization is through flex binning which duplicates traces from neighboring bins to fill holes in coverage. While this method ensures one trace per bin, the flex bin traces will often not be a good representation of what would have been recorded in those bins, particularly for data with significant dip. In addition, jitter can be apparent in the data due to irregular sampling within the bins. The application of traditional methods (such as fx prediction filtering) in such circumstances will be sub-optimal because the irregularity of the sampling makes the primary energy disjointed. As such, the primary energy will be smeared and detail will be lost.

To summarize the shortages of existing methods, many land and ocean bottom datasets suffer from high levels of noise which make the task of processing and interpretation difficult. With legacy land data, high noise levels are generally due to low CMP fold. High fold modern acquisition can also be noisy due to poor geophone coupling, ground or mud roll, or because single sensors rather than arrays are used. As this data often exhibit irregular sampling, denoising it can be difficult with the random noise attenuation algorithms requiring regularly sampled data. Therefore, there is a need in the industry to find a method for denoising this type of data.

### SUMMARY

According to an exemplary embodiment, there is a method for denoising seismic data recorded with seismic receivers (R). The method includes receiving the seismic data recorded with the seismic receivers, wherein the seismic data is recorded in a time-space domain; applying with a computing device a high resolution transform to the seismic data in the time-space domain to obtain transformed seismic data in a different domain than the time-space domain, such that the method is amplitude preserving; determining regions of noise and regions of true signal in the transformed seismic data; scaling down the regions of noise; and reverse transforming the transformed seismic data to the time-space domain.

According to another exemplary embodiment, there is a computing device for denoising seismic data recorded with seismic receivers. The computing device includes an interface configured to receive the seismic data recorded with the seismic receivers, wherein the seismic data is recorded in a time-space domain; and a processor connected to the interface. The processor is configured to implement an algorithm that includes, applying a high resolution transform to the seismic data in the time-space domain to obtain transformed seismic data in a different domain than the time-space domain, such that the algorithm is amplitude preserving, determining regions of noise and regions of true signal in the transformed seismic data, scaling down the regions of noise, and reversing transform the transformed seismic data to the time-space domain.

According to another exemplary embodiment, there is a computer readable medium including computer executable instructions, wherein the instructions, when executed by a processor, implement instructions for denoising seismic data recorded with seismic receivers (R) as noted above.

According to still another exemplary embodiment, there is a method for denoising original seismic data recorded with seismic receivers. The method includes receiving the original seismic data recorded with the seismic receivers, wherein the original seismic data is recorded in a time-space domain; applying with a computing device a high resolution transform to the original seismic data in the time-space domain to obtain transformed seismic data in a different domain than the time-space domain, such that the method is amplitude preserving; determining regions of noise and regions of true signal in the transformed seismic data; scaling down the regions of true signal to generate a noise model; reverse transforming the noise model to the time-space domain at coordinates identical to those of the original seismic data; and subtracting the noise model from the original seismic data to obtain denoised seismic data.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a flowchart of an algorithm for denoising seismic data according to an exemplary embodiment;

FIG. 2 is a schematic diagram of a seismic survey system;

FIG. 3 is a schematic diagram of a source and receiver system that illustrates their coordinates;

FIG. 4 is a schematic diagram of a model used to generate synthetic data according to an exemplary embodiment;

FIG. 5 is a graph that illustrates the synthetic data according to an exemplary embodiment;

FIG. 6 is a graph illustrating an azimuth of the recorded data according to an exemplary embodiment;

FIG. 7 is a graph illustrating the synthetic data “contaminated” with noise according to an exemplary embodiment;

FIG. 8 is a graph illustrating the contaminated data denoised based on a 3D algorithm according to an exemplary embodiment;

FIG. 9 is a graph illustrating a difference between the contaminated data and the 3D denoised data according to an exemplary embodiment;

FIG. 10 is a graph illustrating the contaminated data denoised based on a 5D algorithm according to an exemplary embodiment;

FIG. 11 is a graph illustrating a difference between the contaminated data and the 5D denoised data according to an exemplary embodiment;

FIG. 12 is a flowchart of a method for denoising data according to an exemplary embodiment; and

FIG. 13 is a schematic diagram of a computing device for denoising data according to an exemplary embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to seismic data that is denoised based on a multi-dimensional, coherency driven algorithm. The embodiments are discussed with regard to irregular data. However, the embodiments to be discussed next are not limited to irregular data, but they may be extended or used with regular data.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an exemplary embodiment, raw seismic data (regular or irregular) is denoised by applying a high-resolution transform followed by separating regions of noise from the regions of true signal, scaling down the regions of noise and then transforming the seismic data back to the original domain, e.g., time-space domain. The method may be amplitude-preserving, and may be applied to three or more dimensions (preferably five). Details of the novel method are now discussed.

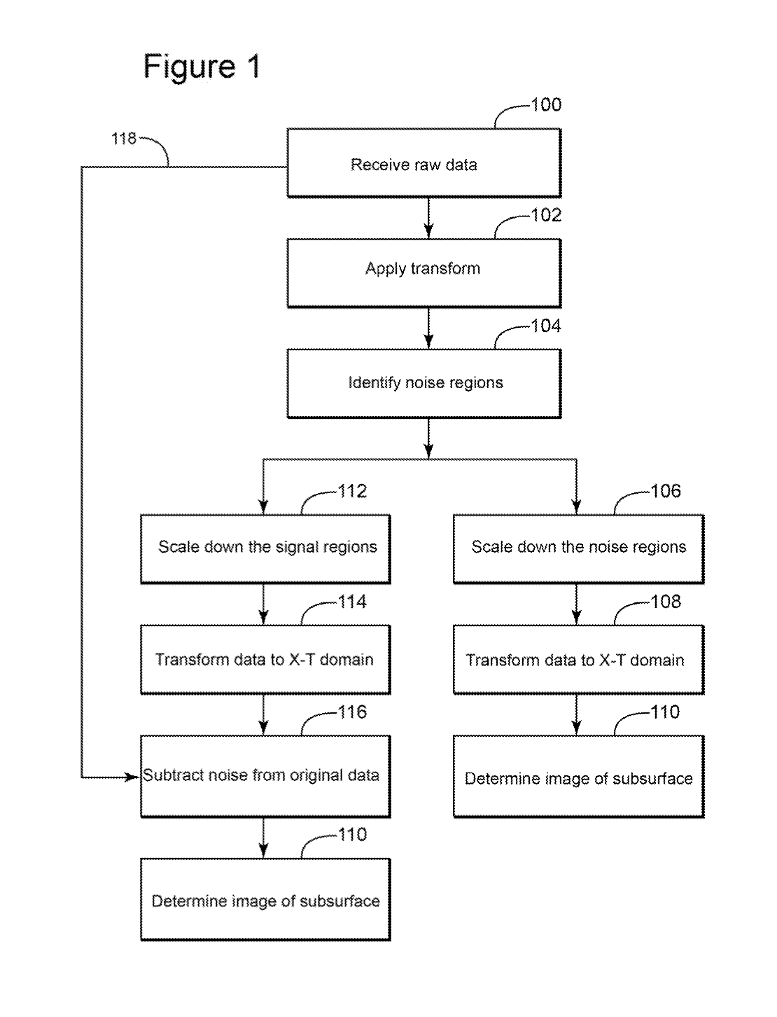

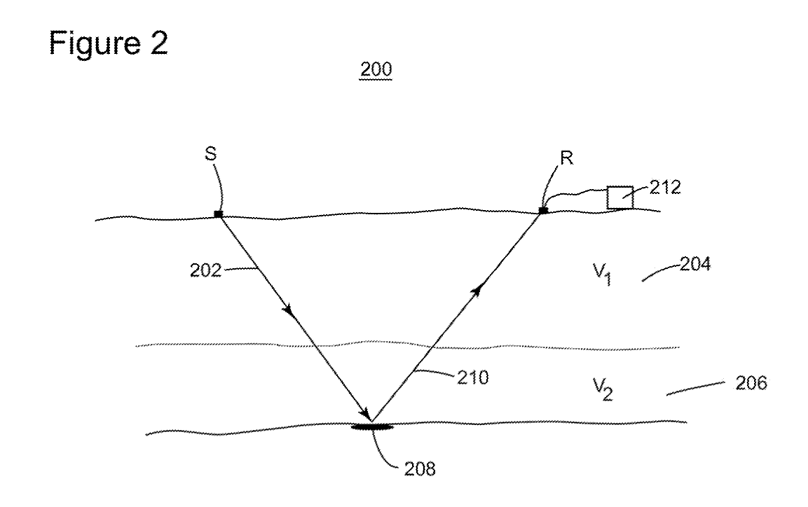

More specifically, as described in FIG. 1, raw seismic data is received in step 100. The raw seismic data can be irregular or regular data. Irregular data is related to the idea of bin. A bin is a subdivision of a seismic survey that has a certain length and width. Traces corresponding to a midpoint between the receiver and the source are associated with the bins. A count (e.g., number of traces in a bin also called fold) in the bin may be any number. If this number is around 15, the data is considered low fold. If the number is around 300, the data is considered high fold. However, these numbers are illustrative only. The raw seismic data can be recorded with a land or marine receiver. The receiver may be any one of a geophone, hydrophone, accelerometer or a combination of them. A seismic system 200 for recording seismic waves that includes at least a receiver R is shown in FIG. 2. The seismic system 200 includes a source S for generating the seismic waves 202. FIG. 2 shows a land seismic source. However, the novel embodiments discussed herein are also applicable to a marine seismic system. FIG. 2 shows that the seismic wave 202 propagates through layers 204 and 206 (two layers for simplicity) having different velocities v1 and v2. The seismic wave 202 is reflected by a reflector 208 and then it propagates upward as seismic wave 210. This wave is recorded by the receiver R and forms the raw seismic data. A control device 212 is provided to receive the raw seismic data from the receiver R and perform some processing on the data. Then, the raw seismic data is provided to a computing device that implements the novel method of denoising.

Returning to FIG. 1, the computing device (to be discussed later) uses the seismic raw data received in step 100 to transform it in step 102 into a slant stack domain. It is noted that the seismic raw data is recorded in the x-t domain. The transform that is applied to the seismic raw data may be a Radon transform. However, if the novel algorithm is desired to be amplitude-preserving and to model the energy beyond aliasing, a high-resolution transform needs to be used instead of the Radon transform, e.g., a high resolution Radon transform (see Herrmann et al., “De-aliased, high-resolution Radon transforms,” 70^{th} SEG Annual International Meeting, Expanded Abstracts, 1953-1956, 2000) or a slant stack equivalent of the anti-leakage Fourier transform (see Xu et al., “Anti-leakage Fourier transform for seismic data regularization,” Geophysics, 70, 87-95, 2005, and Ng and Perz, “High resolution Radon transform in the t-x domain using ‘intelligent’ prioritization of the Gauss-Seidel estimation sequence,” 74^{th} SEG Annual International Meeting, Expanded Abstracts, 2004).

A high-resolution Radon transform is called a tau-p transform, where tau is the time-intercept and p is the slowness. There are variations of the tau-p transform that include linear, parabolic, hyperbolic, shifted hyperbolic, etc. The Radon transform may be solved either in the time- or frequency-domain in a mixture of dimensions, for example tau-pₓ-p_{y}-qₕ, where p relates to linear, q relates to parabolic and x, y, and h refer to the x-, y-, and offset-directions, respectively. An alternative to a Radon transform is to use a sparse FK domain (frequency-wave-number) or any other transform that describes the input data as a linear function. After applying a high-resolution Radon transform to the seismic raw data, transformed seismic data is obtained. The novel algorithm that uses the high-resolution Radon transform is considered to be amplitude-preserving because amplitudes of various recorded events in the seismic raw data are preserved during processing.

The next step 104 of the algorithm involves distinguishing regions of noise from regions of true signal. This identification may be performed by the computing device in the tau-p domain. Alternately, the administrator of the survey may identify or separate the noise regions from the regions of the true signal. Once the noise regions are identified, they are scaled down in step 106. For example, a weight may be attached to the noise regions to diminish their influence.

Scaling in the tau-p domain can be applied to the irregular data, which is not the case of the fx prediction/projection methods that are applicable only to regular data. Thus, although one may consider that the scaling in the tau-p domain is similar to applying fx prediction filtering, the fx prediction is limited to regular data. After scaling down the noise regions, the seismic data is transformed in step 108 back into the x-t domain. The transform applied in step 108 is the reverse of the transform applied in step 102. The denoised data may be used to generate in step 110 an image of a subsurface that was surveyed.

In an alternative application, after the noise regions are identified in step 104, the signal regions may be scaled down in step 112 (instead of scaling down the noise regions as in step 106) in the transform domain, thus generating a noise model. The noise model may then be reverse transformed in step 114 and subtracted from the original data in step 116 before determining the image of the subsurface in step 110. It is noted that, after creating the noise model, the raw data from step 100 may be provided directly to step 116 for reusing the existing noise model for denoising.

The algorithm can either output the data in the original irregular coordinates or in other specified coordinates. This last property allows the dataset to be denoised, regularized or mapped in the coordinates of a secondary dataset. For example, another vintage of a time-lapse study may be used. Of course, the denoised data may be used for many other purposes as known in the field.

The novel denoising algorithm can be improved by applying it in 5D. Tau-p-based coherency enhancement can be extended to work in 5D using simultaneously, for example, inline (to be defined later), cross-line (to be defined later), offset-x, and offset-y directions together with the time, to enhance the actual signal. Thus, the novel algorithm illustrated in FIG. 1 is based on a multi-dimensional, coherency driven, approach for suppressing the random noise on irregularly sampled data.

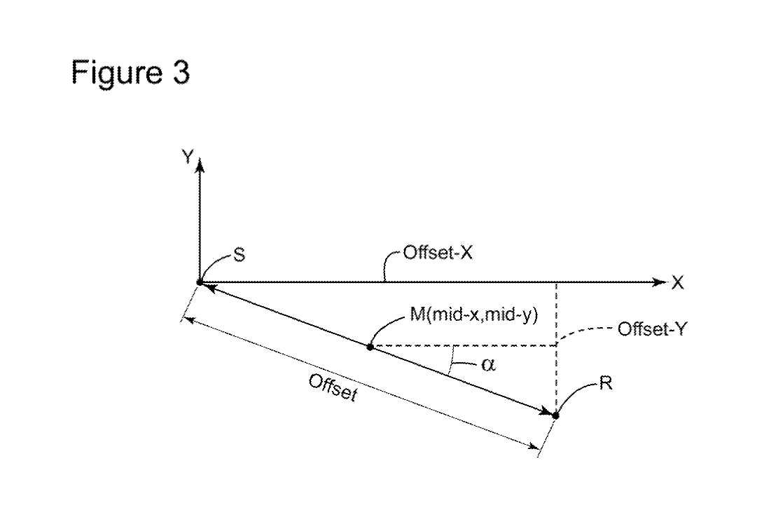

Regarding the 5D system of this novel algorithm, it is noted that the existing methods traditionally use a 3D system, e.g., x, y, and time t. While the novel algorithm may use the 3D system, it may also use the 5D system, which is illustrated in FIG. 3. FIG. 3 shows a source S and a receiver R separated by a distance “offset.” A middle point M of the offset is also shown in the figure. The offset may have a component offset-x on the X axis and a component offset-y on the Y axis. The 5D system may include other sets of dimensions, for example, mid-x, mid-y, offset, azimuth and time; or mid-x, mid-y, offset-x, offset-y and time; or source-x coordinate, source-y coordinate, receiver-x coordinate, receiver-y coordinate, time, etc. The mid-x is the X coordinate of the middle point M, mid-y is the Y coordinate of the middle point M, inline is defined as mid-x divided by a bin size along x, and cross-line is defined as mid-y divided by a bin size along y.

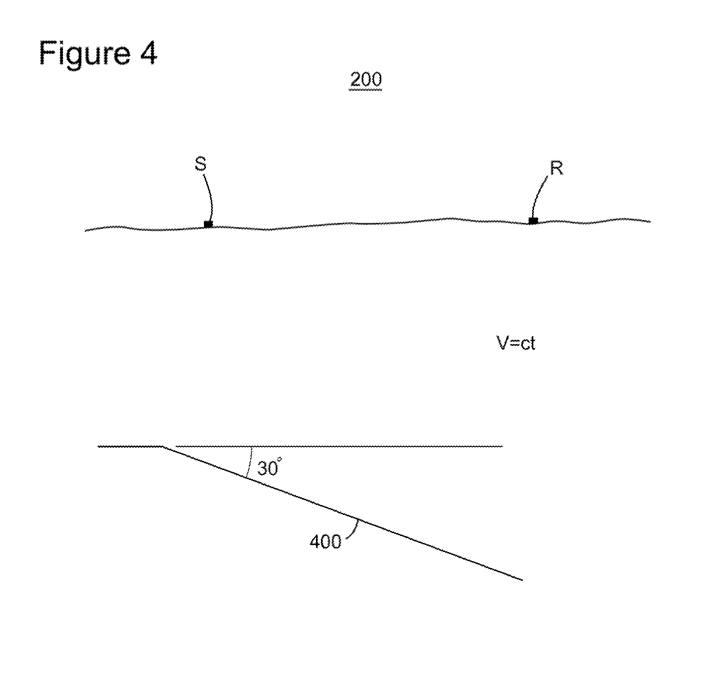

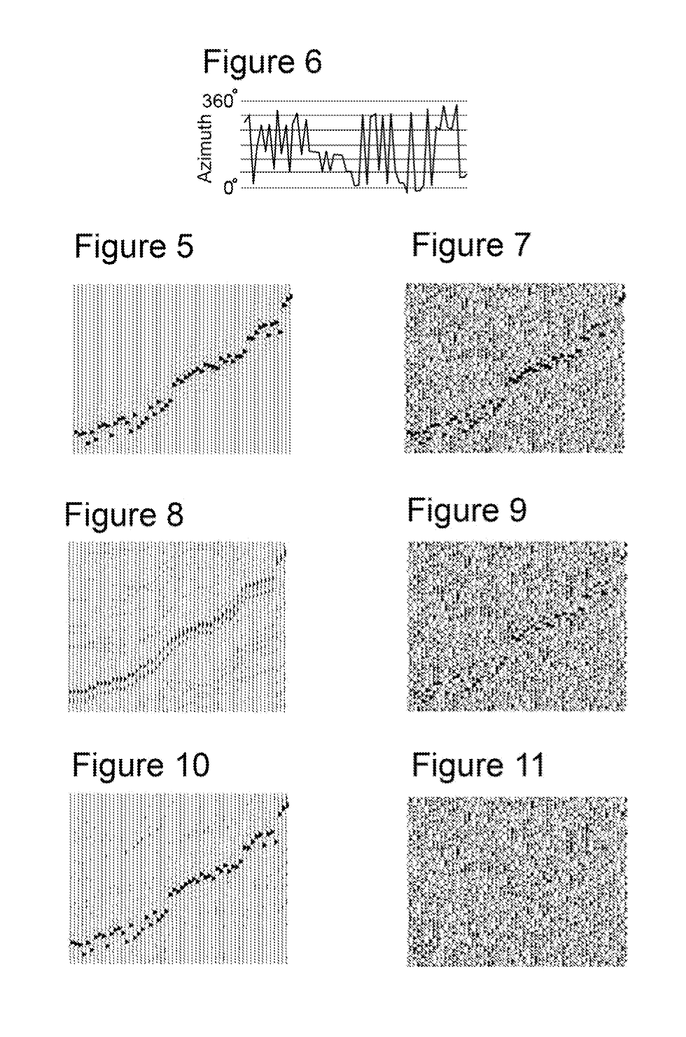

The proposed algorithm offers more flexibility in controlling the level of denoising as discussed next with regard to a synthetic dataset. The synthetic dataset was generated using shot and receiver coordinates from a real land dataset with irregular spacing and poor sampling (approximately 15 fold). The model is based on a constant velocity medium (2000 m/s) with a single dipping horizon (30° dip) 400 as illustrated in FIG. 4. An inline from the dataset for offset range 1,000 m to 1,100 m is shown in FIG. 5, where significant jitter is observed due to holes in coverage and variation in azimuth (see FIG. 6).

Random noise is added to the dataset as shown in FIG. 7 to simulate the raw seismic data. Then, the novel algorithm illustrated in FIG. 1 is applied both in 3D and 5D to denoise the raw seismic data illustrated in FIG. 7. The 3D algorithm used the inline and cross-line directions to denoise the data, and its output is displayed in FIG. 8, with a difference between the denoised data of FIG. 8 and the raw seismic data of FIG. 7 being illustrated in FIG. 9. The results of the 5D algorithm (inline-crossline-offset-azimuth-time) are shown in FIG. 10, and a difference between the denoised data of FIG. 10 and the raw data of FIG. 7 is illustrated in FIG. 11.

It is observed that while the 3D application has removed much of the noise, significant damage to the signal can be observed in FIG. 8 when compared with the original signal of FIG. 5. This is due to the azimuth-related jitter not being modeled by the applied transform. A similar level of denoising is observed for the 5D application but with an improved preservation of the primary energy when comparing the signal of FIG. 10 with the original signal of FIG. 5. By operating in 5D, the novel algorithm can model the variation of the reflected energy with all spatial coordinates and, thus, it is able to preserve the clarity of the event.

Thus, one or more of the exemplary embodiments discussed above has introduced a new coherency driven random noise attenuation method in the high-resolution tau-p domain. The method has benefits over traditional denoising algorithms because it offers high flexibility in the level of denoising, can work directly with irregular data, and can be applied in up to five dimensions (inline, cross-line, offset-x, offset-y, and time). The large number of dimensions avoids cascaded applications of lower dimensional algorithms which only work on small subsets of the available data and are less effective at enhancing weak signals hidden under high-amplitude noise. The power of the technique has been illustrated on synthetic data. The resulting pre- and post-stack data exhibits improved continuity whilst preserving the weak reflected energy.

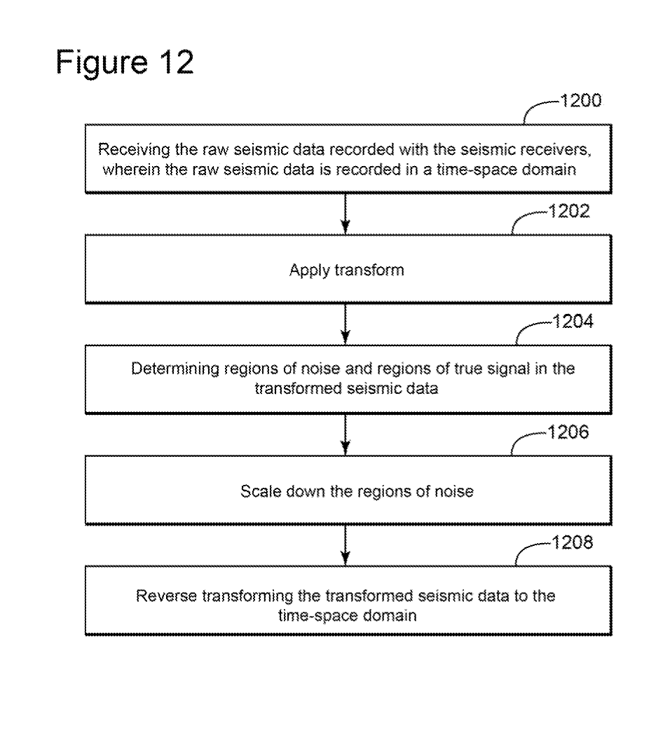

Therefore, a novel method that implements the algorithm illustrated in FIG. 1 may be run on a computing device. According to an exemplary embodiment illustrated in FIG. 12, there is a method for denoising raw seismic data recorded with seismic receivers. The method includes a step 1200 of receiving the raw seismic data recorded with the seismic receivers, wherein the raw seismic data is recorded in a time-space domain; a step 1202 of applying with a computing device a high-resolution transform to the raw seismic data in the time-space domain to obtain transformed seismic data in a different domain than the time-space domain, such that the method is amplitude-preserving; a step 1204 of determining regions of noise and regions of true signal in the transformed seismic data; a step 1206 of scaling down the regions of noise; and a step 1208 of reverse transforming the transformed seismic data to the time-space domain.

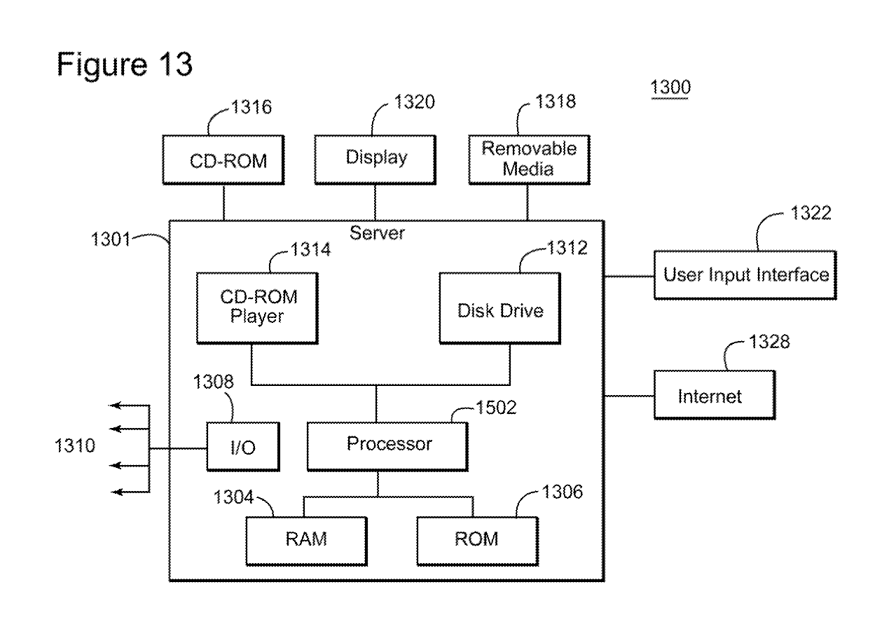

An example of a representative computing device capable of carrying out operations in accordance with the exemplary embodiments discussed above is illustrated in FIG. 13. Hardware, firmware, software or a combination thereof may be used to perform the various steps and operations described herein.

The exemplary computer device 1300 suitable for performing the activities described in the exemplary embodiments may include server 1301. Such a server 1301 may include a central processor unit (CPU) 1302 coupled to a random access memory (RAM) 1304 and to a read-only memory (ROM) 1306. The ROM 1306 may also be other types of storage media to store programs, such as programmable ROM (PROM), erasable PROM (EPROM), etc. The processor 1302 may communicate with other internal and external components through input/output (I/O) circuitry 1308 and bussing 1310, to provide control signals and the like. The processor 1302 carries out a variety of functions as are known in the art, as dictated by software and/or firmware instructions.

The server 1301 may also include one or more data storage devices, including hard disk drives 1312, CD-ROM drives 1314, and other hardware capable of reading and/or storing information such as a DVD, etc. In one embodiment, software for carrying out the above-discussed steps may be stored and distributed on a CD-ROM or DVD 1316, removable media 1318 or other form of media capable of portably storing information. These storage media may be inserted into, and read by, devices such as the CD-ROM drive 1314, the disk drive 1312, etc. The server 1301 may be coupled to a display 1320, which may be any type of known display or presentation screen, such as LCD or LED displays, plasma displays, cathode ray tubes (CRT), etc. A user input interface 1322 is provided, including one or more user interface mechanisms such as a mouse, keyboard, microphone, touch pad, touch screen, voice-recognition system, etc.

The server 1301 may be coupled to other computing devices via a network. The server may be part of a larger network configuration as in a global area network (GAN) such as the Internet 1328.

As also will be appreciated by one skilled in the art, the exemplary embodiments may be embodied in a wireless communication device, a telecommunication network, as a method or in a computer program product. Accordingly, the exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer-readable medium may be utilized including hard disks, CD-ROMs, digital versatile discs (DVD), optical storage devices, or magnetic storage devices such a floppy disk or magnetic tape. Other non-limiting examples of computer-readable media include flash-type memories or other known types of memories.

The disclosed exemplary embodiments provide an apparatus and a method for seismic data denoising. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for denoising seismic data recorded with seismic receivers (R), the method comprising:
receiving the seismic data recorded with the seismic receivers, wherein the seismic data is recorded in a time-space domain;
applying with a computing device a high resolution transform to the seismic data in the time-space domain to obtain transformed seismic data in a different domain than the time-space domain, such that the method is amplitude preserving;
determining regions of noise and regions of true signal in the transformed seismic data;
scaling down the regions of noise; and
reverse transforming the transformed seismic data to the time-space domain.

2. The method of claim 1, wherein the seismic data includes irregular data.

3. The method of claim 1, wherein the high resolution transform is applied to five different parameters of the seismic data.

4. The method of claim 3, wherein the five different parameters include inline, crossline, offset-x, and offset-y directions and time.

5. The method of claim 3, wherein the five different parameters include inline, crossline, offset, and azimuth directions and time.

6. The method of claim 1, wherein the high resolution transform includes one of a high resolution Radon transform or a slant stack equivalent of an anti-leakage Fourier transform.

7. The method of claim 6, wherein the high resolution Radon transform is one of a linear, parabolic, hyperbolic, or shifted hyperbolic transform.

8. The method of claim 1, wherein a method is amplitude preserving when an amplitude of a recorded event in the seismic data is preserved during processing.

9. The method of claim 1, further comprising:
outputting data as a consequence of the reverse transforming step in an original coordinate system or another coordinate system.

10. The method of claim 1, further comprising:
generating an image of the subsurface based on the reverse transformed data.

11. A computing device for denoising seismic data recorded with seismic receivers (R), the computing device comprising:
an interface configured to receive the seismic data recorded with the seismic receivers, wherein the seismic data is recorded in a time-space domain; and
a processor connected to the interface and configured to implement an algorithm that includes,
applying a high resolution transform to the seismic data in the time-space domain to obtain transformed seismic data in a different domain than the time-space domain, such that the algorithm is amplitude preserving,
determining regions of noise and regions of true signal in the transformed seismic data,
scaling down the regions of noise, and
reversing transform the transformed seismic data to the time-space domain.

12. The computing device of claim 11, wherein the seismic data includes irregular data.

13. The computing device of claim 12, wherein the irregular data corresponds to bins having folds lower than corresponding folds of regular data.

14. The computing device of claim 11, wherein the high resolution transform is applied to five different parameters of the seismic data.

15. The computing device of claim 11, wherein the processor is further configured to:
output data as a consequence of the reverse transforming in an original coordinate system or another coordinate system.

16. A computer readable medium including computer executable instructions, wherein the instructions, when executed by a processor, implement instructions for denoising seismic data recorded with seismic receivers (R), the instructions comprising:
receiving the seismic data recorded with the seismic receivers, wherein the seismic data is recorded in a time-space domain;
applying with a computing device a high resolution transform to the seismic data in the time-space domain to obtain transformed seismic data in a different domain than the time-space domain, such that the method is amplitude preserving;
determining regions of noise and regions of true signal in the transformed seismic data;
scaling down the regions of noise; and
reverse transforming the transformed seismic data to the time-space domain.

17. A method for denoising original seismic data recorded with seismic receivers (R), the method comprising:
receiving the original seismic data recorded with the seismic receivers, wherein the original seismic data is recorded in a time-space domain;
applying with a computing device a high resolution transform to the original seismic data in the time-space domain to obtain transformed seismic data in a different domain than the time-space domain, such that the method is amplitude preserving;
determining regions of noise and regions of true signal in the transformed seismic data;
scaling down the regions of true signal to generate a noise model;
reverse transforming the noise model to the time-space domain at coordinates identical to those of the original seismic data; and
subtracting the noise model from the original seismic data to obtain denoised seismic data.

18. The method of claim 17, further comprising:
generating an image of the subsurface based on the denoised seismic data.

19. The method of claim 17, wherein the original seismic data includes irregular data.

20. The method of claim 17, wherein the high resolution transform is applied to five different parameters of the seismic data.

21. The method of claim 20, wherein the five different parameters include inline, crossline, offset-x, and offset-y directions and time.

22. The method of claim 20, wherein the five different parameters include inline, crossline, offset, and azimuth directions and time.
